(19) United States
(12) Patent Application Publication
(10) Pub. No.: US 2010/0033078 A1
(43) Pub. Date: Feb. 11, 2010

(54) Organic light emitting display device

(75) Inventors: So-Young Lee, Yongin-City (KR); Jong-Hyuk Lee, Yongin-City (KR); Sun-Young Lee, Yongin-City (KR); Yoon-Hyeung Cho, Yongin-City (KR); Min-Ho Oh, Suwon-si (KR); Byoung Duk Lee, Yongin-City (KR)

Correspondence Address: ROBERT E. BUSHNELL & LAW FIRM, 2029 K STREET NW, SUITE 600, WASHINGTON, DC, 20006-1004, US

(73) Assignee: SAMSUNG Mobile Display Co., LTD, Yongin-City (KR)

(21) Appl. No.: 12/461,121

(22) Filed: Jul. 31, 2009

(30) Foreign Application Priority Data
Aug. 7, 2008 (KR) 10-2008-0077549

(51) Int. Cl. H01J 1/62

(52) U.S. Cl. 313/498

(57) ABSTRACT

An organic light emitting display (OLED) device that can improve light coupling efficiency by causing laterally emitted light emitted from an organic light emitting layer to travel in a direction in which an image is formed, resulting in reduced color mixing between pixels by reducing the leakage of internal light. The OLED device includes a substrate, a first electrode arranged on the substrate, a light scattering layer arranged on the substrate and covering a portion of the first electrode and having an opening exposing a portion of the first electrode, a second electrode arranged on the light scattering layer and within the opening facing the first electrode and an organic light emitting layer arranged within the opening between the first electrode and the second electrode.

### CLAIM OF PRIORITY

This application makes reference to, incorporates the same herein, and claims all benefits accruing under 35 U.S.C.§119 from an application for ORGANIC LIGHT EMITTING DISPLA4Y DEVICE earlier filed in the Korean Intellectual Property Office on 7 Aug. 2008 and there duly assigned Serial No. 10-2008-0077549.

### BACKGROUND OF THE INVENTION

1. Field of the Invention

The present invention relates to an organic light emitting display (OLED) device that can 1I improve light coupling efficiency and prevent color mixing between pixels.

2. Description of the Related Art

OLED devices are self-luminous display devices that emit light by electrically exciting an organic compound. OLED devices are drawing a great deal of attention as next generation display devices because of their low driving voltages, thin design, wide viewing angles, and fast response times which overcome the weaknesses of liquid crystal display (LCD) devices.

However, in a conventional OLED device, light emitted from an organic layer arranged between facing electrodes is not only transmitted to the electrodes but is also laterally transmitted in a direction substantially parallel to surfaces of the electrodes. The laterally transmitted light is lost. Accordingly, the conventional OLED device has the disadvantage of low light coupling efficiency due to its structural limitation. In order to improve light coupling efficiency, attempts to use an optical structure, such as a microcavity, an aerosol, a micro lens array, or a diffractive grating have been made. However, such optical structures are difficult to manufacture and have small reproduction margins.

Also, conventional OLED devices have another disadvantage in that since internal light of one pixel leaks into adjacent pixels, color mixing between the pixels occurs. In particular, if a photosensor is installed in each pixel, the photosensor can operate improperly due to the leakage of internal light. What is therefore needed is a design for an OLED device that eliminates color mixing between pixels while preventing the laterally transmitted light from being lost.

### SUMMARY OF THE INVENTION

The present invention provides an OLED device that can improve light coupling efficiency by scattering light that is laterally emitted from an organic light emitting layer to a direction in which an image is formed.

The present invention also provides an OLED device that can reduce color mixing between pixels by reducing the leakage of internal light.

According to an aspect of the present invention, there is provided an OLED device that includes a substrate, a first electrode arranged on the substrate, a light scattering layer arranged on the substrate and covering a portion of the first electrode and having an opening exposing a portion of the first electrode, a second electrode arranged on the light scattering layer and within the opening facing the first electrode and an organic light emitting layer arranged within the opening between the first electrode and the second electrode. The light scattering layer can include a base including a transparent insulating material having a first refractive index and a plurality of fine particles including a material having a second refractive index that is higher than the first refractive index. The fine particles can be arranged within the base at a concentration of 5 to 50%. The fine particles can be one of titanium oxide, zirconium oxide and zinc oxide. The fine particles can have an average particle size of 50 to 500 nm.

According to another aspect of the present invention, there is provided an OLED device having an organic light emitting device that includes a first electrode and a second electrode facing each other, an organic light emitting layer arranged between the first electrode and the second electrode, wherein light emitted from the organic light emitting layer within an effective viewing angle range is transmitted along a first optical path and light emitted from the organic light emitting layer outside the effective viewing angle range is transmitted along a second optical path and a light scattering layer to allow the second optical path to pass therethrough and having an opening corresponding to the first optical path to prevent a main image transmitted along the first optical path from interfering with the light scattering layer. The light scattering layer can include a base including a transparent insulating material having a first refractive index and a plurality of fine particles including a material having a second refractive index that is higher than the first refractive index. The fine particles can be arranged within the base at a concentration of 5 to 50%. The fine particles can be one of titanium oxide, zirconium oxide and zinc oxide. The fine particles can have an average particle size of 50 to 500 nm.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of an OLED device according to an embodiment of the present invention;

FIG. 2 is a cross-sectional view of a top emission active matrix (AM) OLED device according to another embodiment of the present invention; and

FIG. 3 is a cross-sectional view of a bottom emission AM OLED device according to yet another embodiment of the present invention.

### DETAILED DESCRIPTION OF THE INVENTION

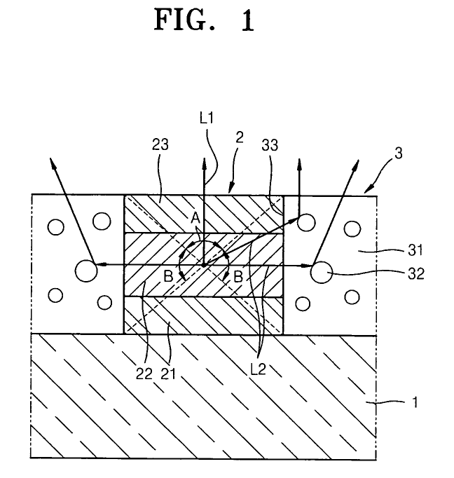

Turning now to FIG. 1, FIG. 1 is a cross-sectional view of an OLED device according to an embodiment of the present invention. Referring to FIG. 1, the OLED device includes an organic light emitting diode 2 and a light scattering layer 3 which are formed on a substrate 1. The organic light emitting diode 2 includes a first electrode 21 and a second electrode 23 which face each other, and an organic light emitting layer 22 arranged between the first electrode 21 and the second electrode 23. The first electrode 21 and the second electrode 23 can have opposite polarities, and thus can be an anode and a cathode, respectively, or vice versa.

The first electrode 21 and the second electrode 23 apply voltages of opposite polarities to the organic light emitting layer 22 arranged between the first electrode 21 and the second electrode 23 so that the organic light emitting layer 22 can emit light. The OLED device of FIG. 1 is a top emission OLED device where light is emitted away from the substrate 1. In this case, the first electrode 21 can include a light reflector, and the second electrode 23 can be transparent to light.

Regardless of the polarities, one electrode acting as an anode should include a conductor having a high work function and the other electrode acting as a cathode should include a conductor having a low work function. Examples of conductors having a high work function include a transparent conductive oxide such as indium tin oxide (ITO), In_{2O3}, ZnO, or indium zinc oxide (IZO), or a noble metal such as Au. Examples of a conductor with a low work function can include Ag, Al, Mg, Li, Ca, LiF/Ca, or LiF/Al.

To this end, if the first electrode 21 is an anode, the first electrode 21 can be formed by preparing a light reflector made out of Ag, Mg, Al, Pt, Pd, Au, Ni, Nd, Ir, Cr, or a compound thereof and coating a material with a high work function, such as ITO, IZO, ZnO, or In₂O₃, on the light reflector. If the first electrode 21 is a cathode, the first electrode 21 can be made out of a light-reflective material with a low work function such as Ag, Al, Mg, Li, Ca, LiF/Ca, or LiF/Al.

If the second electrode 23 is a cathode, the second electrode 23 can be a thin translucent layer using a metal with a low work function, such as Li, Ca, LiF/Ca, LiF/Al, Al, Mg, or Ag. Naturally, a problem of high resistance due to the thinness of the translucent layer can be overcome by forming a transparent conductor, such as ITO, IZO, ZnO, or In₂O₃, on the translucent layer. If the second electrode 23 is an anode, the second electrode 23 can be ITO, IZO, ZnO, or In₂O₃. The materials of the first electrode 21 and the second electrode 23 are not limited thereto and it is obvious to one of ordinary skill in the art that other materials can be used and still be within the scope of the present invention.

The organic light emitting layer 22 can be a low molecular organic layer or a high 8 molecular organic layer. If the organic light emitting layer 22 is a low molecular organic layer, the organic light emitting layer 22 can include a hole injection layer (HIL), a hole transport layer (HTL), an emission layer (EML), an electron transport layer (ETL), or an electron injection layer (EIL), or a stack structure thereof. The low molecular organic layer can be made out of copper phthalocyanine (CuPc), N,N′-Di(naphthalene-1-yl)-N,N′-diphenyl-benzidine (NPB), or tris-8-hydroxyquinoline aluminum (Alq3) by vacuum deposition.

If the organic light emitting layer 22 is a high molecular organic layer, the organic light emitting layer 22 can include an HTL and an EML. The HTL can be formed poly(3,4-ethylenedioxythiophene (PEDOT) and the EML can be made out of a poly-phenylenevinylene (PPV)-based polymer or a polyfluorene-based polymer by screen printing or inkjet printing. The organic light emitting layer 22 is not limited thereto, and various modifications can be made thereto.

Light generated by the organic light emitting layer 22 of the organic light emitting diode 2 is emitted in many directions, both within and outside of an effective viewing angle range A as shown in FIG. 1. Here, the effective viewing angle range A refers to a range of propagation directions that reach a viewer external to the display. Since the OLED device of FIG. 1 is of a top emission type, the observer views an image on a side opposite to the substrate 1, that is, from above the second electrode 23. Accordingly, the effective viewing angle range A refers to a range in which light emitted from the organic light emitting layer 22 is transmitted though the second electrode 23 and out of the OLED device. Light horizontally emitted from the organic light emitting layer 22 is emitted outside the effective viewing angle range A. That is, when light is emitted from the organic light emitting layer 22 within an angle range B, the light is emitted outside the effective viewing angle range A.

In the present embodiment, light emitted from the organic light emitting layer 22 within the effective viewing angle range A is transmitted along a first optical path LI and light emitted from the organic light emitting layer 22 outside the effective viewing angle range A is transmitted along a second optical path L2. The light scattering layer 3 is arranged beside the organic light emitting diode 2. Accordingly, the light scattering layer 3 is located on the second optical path L2.

The light scattering layer 3 has an opening 33 corresponding to the location of the first optical path L1 so that light scattering layer 3 does not interfere with light traveling along first optical path L1. Since the light scattering layer 3 is located on the second optical path L2, light emitted within the angle range B outside the effective viewing angle range A is transmitted out to the side of the organic light emitting diode 2.

In conventional devices, light transmitted along the second optical path L2 from the organic light emitting layer 22 either becomes lost without forming an effective image or leaks into an adjacent pixel to cause color mixing. However, since the light scattering layer 3 of the OLED device of FIG. 1 is located on the second optical path L2, light transmitted along the second optical path L2 can be scattered and transmitted out of the organic light emitting diode 2 in the same general direction as the first optical path L1. Since this sideways transmitted light is redirected, the light coupling efficiency can be improved due to the presence of the light scattering layer 3.

The light scattering layer 3 of the OLED device of FIG. 1 can include a transparent base 31 and a plurality of fine particles 32 dispersed within the base 31. The base 31 is made out of a transparent insulating material having a first refractive index, and the fine particles 32 are made out of a material having a second refractive index that is higher than the first refractive index.

The base 31 can be made out of one or more of a styrene-based resin, an acrylic resin, a vinyl ester-based resin, a vinyl ether-based resin, a halogen-containing resin, an olefin-based resin, a polyphenylene ether-based resin, a polyphenylene sulfide-based resin, a cellulose derivative, a silicon resin, a rubber, and an elastomer. The first refractive index of base 31 can range from 1.5 to 1.6.

The fine particles 32 can be made out of a material having a refractive index of 1.9 or more, such as a titanium oxide, a zirconium oxide, or a zinc oxide. The fine particles 32 can be dispersed within the base 31 at a concentration of 5 to 50%. If the fine particles 32 are dispersed within the base 31 at a concentration of less than 5%, the light scattering effect is degraded and light coupling efficiency is barely improved. If the fine particles 32 are dispersed in the base 31 at a concentration of greater than 50%, the scattering effect of the light scattering layer 3 is so high that light coupling efficiency can be reduced rather than improved, and contrast can be degraded due to excessive light coupling between pixels.

The fine particles 32 can have an average particle size of 50 to 500 nm. If the fine particles 32 have an average particle size of less than 50 nm, the light scattering effect is degraded. If the fine particles 32 have an average particle size of greater than 500 nm, light coupling efficiency can be reduced rather than improved. Accordingly, the light scattering layer 3 of the OLED device of FIG. 1 causes light emitted to the side of the organic light emitting layer 22 to be transmitted out through the top of the OLED device, thereby further improving light coupling efficiency.

Turning now to FIG. 2, FIG. 2 is a cross-sectional view of an active matrix (AM) OLED device according to another embodiment of the present invention. Referring to FIG. 2, the OLED device includes a thin film transistor (TFT) arranged on a substrate 1.

The TFT includes a semiconductor layer 11, a gate insulating layer 12 covering the semiconductor layer 11, a gate electrode 13 arranged on the gate insulating layer 12, an inter-layer insulating layer 14 covering the gate electrode 13 and the gate insulating layer 12, and a source electrode 15 and a drain electrode 16 arranged on the inter-layer insulating layer 14 and contacting the semiconductor layer 11.

A planarization layer 17 covers the TFT. A first electrode 21 is formed on the planarization layer 17, and a light scattering layer 4 is formed on the first electrode 21 and the planarization layer 17. The light scattering layer 4 has an opening 43 through which part of the first electrode 21 is exposed.

An organic light emitting layer 22 is formed on the first electrode 21 within the opening 43. A second electrode 23 is formed to cover the organic light emitting layer 22 and the light scattering layer 4. The second electrode 23 can be a common electrode that covers all pixels.

Since the AM OLED device of FIG. 2 is a top emission AM OLED device where light is emitted toward the second electrode 23, the first electrode 21 can be a reflective layer and the second electrode 23 can be transparent to light.

The light scattering layer 4 of the AM OLED device of FIG. 2 includes a base 41 and a plurality of fine particles 42 dispersed within the base 41, similar to the light scattering layer 3 of the OLED device of FIG. 1. The material of the light scattering layer 4 of the AM OLED device of FIG. 2 is the same as that of the light scattering layer 3 of the OLED device of FIG. 1.

Accordingly, a main image is produced in the arrow direction of FIG. 2, and part of light emitted outside an effective viewing angle range and into the light scattering layer 4 can be scattered and emitted out the top of the AM OLED device by the plurality of fine particles 42 within the light scattering layer 4. Accordingly, the light emitted into the light scattering layer 4 can be prevented from leaking into an adjacent pixel and causing color mixing.

Although not shown, if a photosensor is arranged under the organic light emitting diode 2, the photosensor can be prevented from improperly operating due to the leakage of the light emitted into the light scattering layer 4.

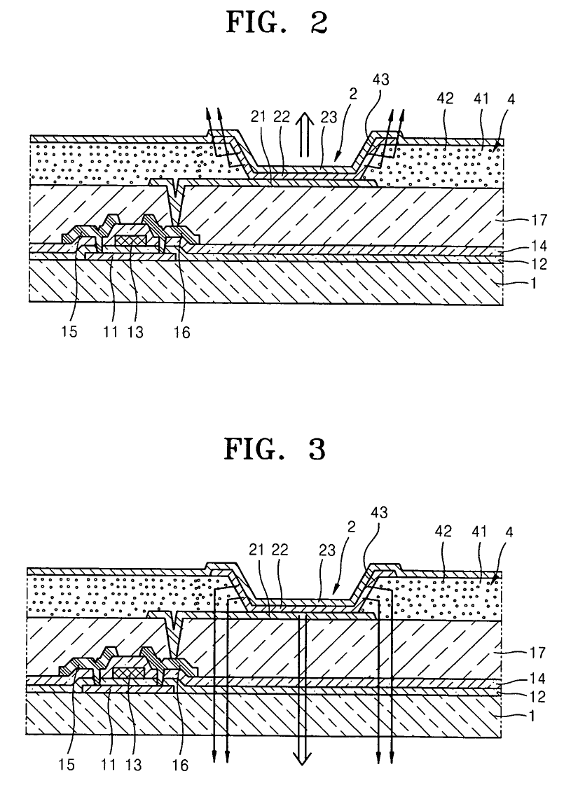

Turning now to FIG. 3, FIG. 3 is a cross-sectional view of an AM OLED device according to another embodiment of the present invention. The AM OLED device of FIG. 3 is structurally similar to the AM OLED device of FIG. 2, except that the AM OLED device of FIG. 3 is a bottom emission AM OLED device where light is emitted toward a substrate 1. Accordingly, in FIG. 3, a second electrode 23 can include a reflective layer and a first electrode 21 can be transparent to light.

Although the AM OLED device of FIG. 3 is of a bottom emission type, part of light emitted into a light scattering layer 4 can be scattered and transmitted into the substrate 1 by the light scattering layer 4, thereby further improving light coupling efficiency.

As described above, since part of light emitted outside an effective viewing angle range is scattered and transmitted to the outside of an organic light emitting device to form an image, light coupling efficiency can be improved. Furthermore, since light is prevented from leaking into an adjacent pixel, color mixing can be reduced. Moreover, even if a photosensor is installed, the photosensor can be prevented from improperly operating due to the leakage of internal light.

While the present invention has been particularly shown and described with reference to exemplary embodiments thereof, it will be understood by those of ordinary skill in the art that various changes in form and details can be made therein without departing from the spirit and scope of the present invention as defined by the following claims.

What is claimed is:

1. An organic light emitting display (OLED) device, comprising:
a substrate;
a first electrode arranged on the substrate;
a light scattering layer arranged on the substrate and covering a portion of the first electrode and having an opening exposing a portion of the first electrode;
a second electrode arranged on the light scattering layer and within the opening facing the first electrode; and
an organic light emitting layer arranged within the opening between the first electrode and the second electrode.

2. The OLED device of claim 1, wherein the light scattering layer comprises:
a base including a transparent insulating material having a first refractive index; and
a plurality of fine particles including a material having a second refractive index that is higher than the first refractive index.

3. The OLED device of claim 2, wherein the fine particles are arranged within the base at a concentration of 5 to 50%.

4. The OLED device of claim 2, wherein the fine particles comprise a material selected from a group consisting of titanium oxide, zirconium oxide and zinc oxide.

5. The OLED device of claim 2, wherein the fine particles have an average particle size of 50 to 500 nm.

6. An organic light emitting display (OLED) device comprising an organic light emitting device that includes:
a first electrode and a second electrode facing each other;
an organic light emitting layer arranged between the first electrode and the second electrode, wherein light emitted from the organic light emitting layer within an effective viewing angle range is transmitted along a first optical path and light emitted from the organic light emitting layer outside the effective viewing angle range is transmitted along a second optical path; and
a light scattering layer to allow the second optical path to pass therethrough and having an opening corresponding to the first optical path to prevent a main image transmitted along the first optical path from interfering with the light scattering layer.

7. The OLED device of claim 6, wherein the light scattering layer comprises:
a base including a transparent insulating material having a first refractive index; and
a plurality of fine particles including a material having a second refractive index that is higher than the first refractive index.

8. The OLED device of claim 7, wherein the fine particles are arranged within the base at a concentration of 5 to 50%.

9. The OLED device of claim 7, wherein the fine particles are comprised of a material selected from a group consisting of titanium oxide, zirconium oxide and zinc oxide.

10. The OLED device of claim 7, wherein the fine particles have an average particle size of 50 to 500 nm.
